(19) United States
(12) Patent Application Publication
(10) Pub. No.: US 2011/0211132 A1
(43) Pub. Date: Sep. 1, 2011

(54) GRID SIGNAL RECEIVER AND WIRELESS POINTING SYSTEM HAVING THE SAME

(75) Inventors: Suki Kim, Seoul (KR); Kwang Jae Lee, Seoul (KR); Se Hwan Yun, Seoul (KR)

(73) Assignee: SILICON COMMUNICATIONS TECHNOLOGY CO., LTD., Seoul (KR)

(21) Appl. No.: 13/126,331

(22) PCT Filed: Oct. 27, 2009
(86) PCT No.: PCT/KR2009/006240

§ 371 Date: Apr. 28, 2011

(30) Foreign Application Priority Data
Oct. 28, 2008 (KR) 10-2008-0106175
Oct. 27, 2009 (KR) 10-2009-0102252

(51) Int. Cl. H04N 5/44

(52) U.S. Cl. 348/734; 348/E05.096

(57) ABSTRACT

The present invention relates to a grid signal receiver and a wireless pointing system having the same. The grid signal receiver receives a signal of a grid pattern from a grid signal transmitter and determines motion of the grid signal transmitter, the grid signal receiver including a slope sensor in addition to a motion sensor for sensing motion of a grid, the slope sensor sensing a slope of the grid to sense a slope of the grid signal transmitter.

### TECHNICAL FIELD

The present invention relates to a grid signal receiver and a wireless pointing system having the same.

### BACKGROUND ART

With development of video household appliances such as a television (TV), a digital versatile disc (DVD), a set-top box, an internet protocol (IP) TV, etc., a pointing device such as a mouse for a personal computer (PC) has been urgently required. In particular, since the IPTV has been developed as an alternative to the PC in the average household, there is further needed the pointing device such as the PC mouse. However, a wired device like a general PC mouse cannot be proper for the video household appliances, and therefore the existing TV remote controller is utilized for achieving the pointing device.

There has been disclosed a patent related to a method in which the remote controller is used as the pointing device and generates and transmits light having a grid pattern and a receiver receives it and measures a moving direction, a moving speed, a size, etc of a grid line so as to drive a pointer (Korean Patent Publication No. 10-2008-0064074). FIG. 1 shows a wireless pointing system using such a grid pattern. In the wireless pointing system using the grid pattern, a grid signal transmitter (involved in the remote controller) is provided with a light emitting diode (LED) and a grid generator to generate and transmit the light of the grid pattern, and the light of the transmitted grid pattern is sensed in the form of the grid line by a grid signal receiver so that the moving direction, the moving speed and the size of the grid line can be measured, thereby driving the pointer on the screen of the video home appliance such as the TV or the like.

The grid signal receiver includes two pairs of sensors, i.e., includes a pair of sensors to determine left and right motions, and a pair of sensors to determine up and down motions. A method of determining the motion is as follows.

A) The remote controller having the grid signal transmitter moves to move a generated grid pattern

B) The grid signal receiver receives light of the grid pattern

C) Motion is determined according to received patterns

D) Determined motion is applied to a pointer

FIG. 2 shows an example of determining the motion when the grid signal transmitter moves rightward. The left and right motions and the up and down motions are different in direction but determine the same operation, and thus the pair of up and down sensors is omitted and only the pair of left and right sensors is shown. As shown in FIG. 2, if the grid line passes both two sensors, the motion is generated.

However, because such a grid-pattern wireless pointing method determines the motion on the basis of the light of the grid pattern, an error may occur in the motion as the grid pattern of the light is sloped or as the thickness and the interval of the grid line varies depending on the distance. Particularly, a user moves while holding the remote controller involving the grid signal transmitter by a hand, so that the slope of the grid pattern can frequently happen. The slope of the grid pattern is on the rise as a problem causing a malfunction.

FIG. 3 shows an example that the operational error is caused as the grid pattern is sloped. FIG. 3 illustrates that the grid signal receiver divides the motions of the grid pattern into three frames when a user moves up the remote controller as it is sloped rightward. At this time, because the grid pattern is sloped rightward, the grid line not only moves up but also passes through the pair of sensors for sensing the left and right motions, thereby causing a malfunction of gradually leftward motion. Also, although it is minute, there arises a malfunction that a degree of upward motion is decreased.

### DISCLOSURE

### Technical Problem

To solve the problems of the prior art as described above, an aspect of the present invention is to provide a grid signal receiver, which can prevent a malfunction due to slope of a grid signal transmitter, and a wireless pointing system having the same. That is, an object of the present invention is to provide a grid signal receiver capable of compensating slope of a grid signal transmitter, and a wireless pointing system having the same.

### Technical Solution

In accordance with an aspect of the present invention, there is provided a grid signal receiver that receives a signal of a grid pattern from a grid signal transmitter and determines motion of the grid signal transmitter, the grid signal receiver including a slope sensor in addition to a motion sensor for sensing motion of a grid, the slope sensor sensing a slope of the grid to sense a slope of the grid signal transmitter.

The grid signal receiver may include: a pair of horizontal motion sensors which sense a vertical (Y-axis) pattern of the grid to sense horizontal (X-axis) motion; a pair of vertical motion sensors which sense a horizontal (X-axis) pattern of the grid to sense vertical (Y-axis) motion; and the slope sensor which senses the slope of the grid.

The slope sensor may be arranged not on the same line as the pair of horizontal motion sensors or the pair of vertical motion sensors.

The slope sensor may be arranged in a vertical direction with respect to one of the pair of horizontal motion sensors, or arranged in a horizontal direction with respect to one of the pair of vertical motion sensors.

The slope sensor may be arranged so that a distance between the slope sensor and one horizontal motion sensor arranged in the vertical direction is equal to a distance between the pair of horizontal motion sensors, or a distance between the slope sensor and one vertical motion sensor arranged in the horizontal direction is equal to a distance between the pair of vertical motion sensors.

The slope sensor senses the vertical (Y-axis) pattern together with the pair of horizontal motion sensors and compares relative sensing times of the sensors to calculate slope information of the grid, or the slope sensor senses the horizontal (X-axis) pattern together with the pair of vertical motion sensors and compares relative sensing times of the sensors to calculate slope information of the grid.

A vertical (Y-axis) pattern signal and a horizontal (X-axis) pattern signal of the grid may be different in a frequency band. Further, each sensor may include a photodiode to sense a grid signal; and an optical filter to pass the frequency band of the grid signal.

The vertical (Y-axis) pattern signal and the horizontal (X-axis) pattern signal of the grid may be different in the frequency band, the horizontal motion sensor and the vertical motion sensor may be provided with optical filters to pass the frequency bands of the vertical (Y-axis) pattern signal and the horizontal (X-axis) pattern signal, respectively, and the slope sensor may include an optical filter that passes either frequency band of the vertical (Y-axis) pattern signal or the horizontal (X-axis) pattern signal.

The grid signal receiver may further include a motion vector processor that receives a sensed signal from the respective sensors to process a motion vector, and calculates slope information of the grid to compensate the motion vector.

The motion vector processor may include a direction detector to detect a moving direction of the grid; a line detector to generate a pulse every time when one grid line moves; a slope detector to detect a slope of the grid; a motion vector extractor to receive information about the moving direction of the grid from the direction detector and a pulse from the line detector and extract an X-axis motion vector (horizontal motion vector) and a Y-axis motion vector (vertical motion vector); and a slope-based motion vector compensator to compensate the X-axis motion vector and the Y-axis motion vector on the basis of the slope information received from the slope detector.

The motion vector processor may further include a low-pass filter that receives output of the slope-based motion vector compensator and performs low-pass filtering to suppress variation of a motion vector due to noise and shaking generated in a transmitting terminal or a receiving terminal.

The motion vector processor may further include a low-pass filter that performs low-pass filtering by receiving the X-axis motion vector and the Y-axis motion vector of the motion vector extractor to reduce an error that may occur under acceleration or negative-acceleration conditions, and outputs the filtered X-axis and Y-axis motion vectors to the slope-based motion vector compensator.

The motion vector processor may further include an anti-shaking decision unit to estimate shaking, so that the motion vector extractor is halted depending on the decision of the anti-shaking decision unit.

The motion vector processor may include: a direction detector to detect a moving direction of the grid; a line detector to generate a pulse every time when one grid line moves; a slope detector to detect a slope of the grid; a motion vector extractor to receive information about the moving direction of the grid from the direction detector and a pulse from the line detector and extract an X-axis motion vector and a Y-axis motion vector; a pulse width demodulator to convert a certain cycle about the motion of the grid into a digital value; a pulse-based motion vector compensator to compensate the X-axis motion vector and the Y-axis motion vector received from the motion vector extractor on the basis of the converted digital value; and a slope-based motion vector compensator to compensate the X-axis motion vector and the Y-axis motion vector received from the pulse-based motion vector compensator on the basis of the slope information received from the slope detector.

The plurality of sensors may be provided as a first chip, and the motion vector processor may be provided as a second chip different from the first chip.

The plurality of sensors and the motion vector processor may be provided as a single chip.

In accordance with another aspect of the present invention, there is provided a wireless pointing system including: a grid signal transmitter to generate and output a signal having a grid pattern signal; and a grid signal receiver to process a motion vector to receive the signal of the grid pattern and calculate motion, the grid signal receiver including a slope sensor in addition to a motion sensor to sense motion of a grid, so that a slope of the grid signal transmitter is sensed and the motion vector is compensated on the basis of slope information.

### Advantageous Effects

In a grid signal receiver according to exemplary embodiments of the present invention and a wireless pointing system having the same, a wireless pointing function absolutely required in the next-generation video household appliances such as the IPTV or the like.

Particularly, the slope of the grid signal transmitter is sensed and compensated to prevent a malfunction due to the slope of the remote controller. Further, shaking compensation, smooth pointing, etc. can be achieved through various signal processes.

### DETAILED DESCRIPTION OF THE INVENTION

Hereinafter, embodiments of the present invention will now be described with reference to the accompanying drawings so that a person having an ordinary skill in the art can easily realize the present invention.

This invention may, however, be embodied in many different forms and should not be construed as limited to the embodiments set forth herein; rather, these embodiments are provided so that this disclosure will be thorough and complete, and will fully convey the scope of the invention to those skilled in the art.

A grid signal receiver according to an exemplary embodiment of the present invention and a wireless pointing system having the same can sense a slope of a grid signal transmitter and compensate a motion vector according to sensed results, thereby performing a reliable wireless pointing function.

FIG. 4 shows a wireless pointing system 10 according to an exemplary embodiment of the present invention. Referring to FIG. 4, the wireless pointing system 10 in this embodiment includes a grid signal transmitter 100 generating a signal having a grid pattern, and a grid signal receiver 200 receiving the signal having the grid pattern and determining motion on the basis of the received grid signal.

The grid signal transmitter 100 includes a light source (a light emitting diode (LED) may be used by way of an example), and a grid generator, so that it can transmits light of a grid pattern to implement a pointing function. The transmitted light of the grid pattern is sensed in the form of a grid line by the grid signal receiver 200, and a moving direction and a moving speed thereof are calculated to obtain a motion vector, thereby operating a pointer on a screen of the video house hold appliances such as the digital TV or the like. Below, the wireless pointing system 10 in this embodiment will be described in more detail with reference to FIG. 4.

The grid signal transmitter 100 includes a microcomputer 120, an X-grid generator 140, a Y-grid generator 145, a first lens 160, and a second lens 165. The grid signal transmitter 100 may generate an infrared signal having a grid pattern (light other than the infrared light may be used as long as it is within the scope of the present invention).

The microcomputer 120 may generate a signal having a carrier frequency in each axis (X axis and Y axis). Here, the X axis refers to an axis where the grid signal transmitter 100 generates a grid line in a horizontal direction, and the Y axis refers to an axis where the grid signal transmitter 100 generates a grid line in a vertical direction. The signal generated at this time may be converted into the infrared signal through an infrared LED. At this time, the X-axis carrier frequency signal and the Y-axis carrier frequency signal may use the same frequency, but preferably use different frequencies to prevent interference. For example, the X-axis carrier frequency signal may be generated within a range from 30 to 40 KHz, and the Y-axis carrier frequency signal may be generated within a range from 41 to 50 KHz.

The X-grid generator 140 may receive the X-axis carrier frequency signal and generate an X-axis pattern (IRX). That is, the X-axis generator 140 transmits the light emitted from the LED, thereby generating the X-axis pattern (IRX). The Y-grid generator 145 may receive the Y-axis carrier frequency signal and generate a Y-axis pattern (IRY). That is, the Y-axis generator 145 transmits the light emitted from the LED, thereby generating the Y-axis pattern (IRY). The X-grid generator 140 and the Y-grid generator 145 may be provided as plates etched to have the X-axis pattern and the Y-axis pattern, respectively, and may be made of glass or the like which can transmit the light (infrared light).

The first lens 160 transmits the X-axis pattern (IRX) and projects it onto the grid signal receiver 200. The second lens 165 transmits the Y-axis pattern (IRY) and projects it onto the grid signal receiver 200. Here, the first and second lenses 160 and 165 are made of a material capable of transmitting the light (infrared light).

In this embodiment, the grid signal transmitter 100 generates the X-axis pattern signal and the Y-axis pattern signal individually as described above, but not limited thereto. Alternatively, the X-axis pattern and the Y-axis pattern may be generated at the same time (in this case, an XY-grid generator is used as the grid generator), or the grid pattern may be generated using one carrier frequency signal.

Referring to FIG. 4, the grid signal receiver 200 may include a signal receiver 220 to sense an infrared grid signal generated by the grid signal transmitter 100, and a motion vector processor 240 to process a motion vector from the received grid signal.

Contrary to the prior art, the signal receiver 220 further includes a slope sensor E to sense the slope of the grid, and the motion vector processor 240 compensates the motion vector in accordance with the slope sensed by the signal receiver 220. Thus, the direction or the size of the motion vector can be prevented from distortion.

The signal receiver 220 includes horizontal motion sensors A and B to determine the left and right motion (motion in the X-axis), vertical motion sensors C and D to determined the up and down motion (motion in the Y-axis), and the sensor E to determine the slope.

In this embodiment, a method of determining the motion is as follows. The grid signal transmitter 100 moves and thus the grid pattern generated by the grid signal transmitter 100 also moves. The signal receiver 220 of the grid signal receiver 200 may receive the grid light. Then, the direction is determined according to the received patterns. The determined direction is applied to the pointer.

Each sensor A, B, C, D, E is provided as a photo diode capable of sensing the light and converting it into an electric signal. Here, to prevent interference between the horizontal (X) axis and the vertical (Y) axis of the grid, the grid signal transmitter 100 generates the light of the horizontal (X) axis and the vertical (Y) axis to have different frequencies. Thus, each sensor A, B, C, D, E may employ a corresponding optical filter.

The horizontal motion sensors A and B are sensors for determining the left and right (X-axis) motion. The vertical motion sensors C and D are sensors for determining the up and down (Y-axis) motion. The slope sensor E is a sensor for determining the slope of the grid.

The slope sensor E is configured to have the same optical filter as the horizontal motion sensors A and B or the vertical motion sensors C and D, so that the slope sensor E can sense the slope together with the horizontal motion sensors A and B or sense the slope together with the vertical motion sensors C and D.

The horizontal motion sensors A and B are arranged in a horizontal direction, and the vertical motion sensors C and D are arranged in a vertical direction. In the case that the slope sensor E receives the same frequency signal as the horizontal motion sensors A and B (i.e., senses the slope together with the horizontal motion sensors A and B), the slope sensor E can be arranged in any position except a horizontal position on the same line as the horizontal motion sensors A and B.

Also, if the slope sensor E receives the same frequency signal as the vertical motion sensors C and D (i.e., senses the slope together with the vertical motion sensors C and D), the slope sensor E can be arranged in any position except a vertical position on the same line as the vertical motion sensors C and D. Here, whether it is vertical or horizontal is based on the X-axis and the Y-axis of the grid generated in the grid signal transmitter 100.

Below, a method that the slope sensor E senses the slope together with the horizontal motion sensors A and B will be described according to an exemplary embodiment of the present invention.

In this embodiment, the slope may be determined through the sensor A and the sensor E. If the grid is sloped, the sensor A and the sensor E are different in time of receiving the vertical grid patterns. Thus, the slope of the grid signal transmitter 100 is determined. This case is possible if the sensors A and the sensor E are arranged in the vertical direction. Even if they are not arranged in the vertical direction, the slope can be determined by comparing the sensors A, B and E with respect to the sensing time.

Also, the direction and the angle of the sloped grid signal transmitter 100 are determined through the sensors A, B and E.

First, the slope direction of the grid signal transmitter 100 can be determined on the basis of order that the sensors are turned “on”.

Table 1 shows information that can be obtained according to order of sensing the infrared signal. In the following, a reference of 45 degrees can be determined when a distance between the sensors A and B is equal to that between the sensors A and E.

TABLE 1

| | Information | | |
|---|---|---|---|
| Sensing order | Moving direction | Slope direction | remark |
| B-> A-> E | Left | Right | |
| B-> E-> A | Left | Left | |
| E-> B-> A | Left | Left | Slope more than 45 |
| | | | degrees |
| E-> A-> B | Right | Right | |
| A-> E-> B | Right | Left | |
| A-> B-> E | Right | Left | Slope more than 45 |
| | | | degrees |

FIG. 5 shows an example that the grid signal receiver extracts a sloped angle of the grid signal transmitter 100. In the case of the rightward movement, the grid light reaches the sensors in order of E->A->B. In this case, respective reaching times are t_{EA} and t_{AB}. Further, the distance between the sensors is so short that the speed of the rightward motion is rarely varied. Therefore, assume that the motion has a constant velocity, the distance of the motion is in proportion to the time.

s=vt, v=constant Equation 1

Therefore, a ratio of t_{EA} and t_{AB} is equal to that of d_{A} and d_{B}. Further, if the distance between the sensor A and the sensor E is equal to that between the sensor A and the sensor B, d_{B} is equal to d_{E}. Therefore, a ratio of d_{A} and d_{E} is calculated. Through this, a gradient can be calculated by operation of a trigonometrical function.

$$θ = {tan}^{- 1} \frac{{d}_{A}}{{d}_{E}} = {tan}^{- 1} \frac{{d}_{A}}{{d}_{B}} \qquad Equation 2$$

The gradient calculated by this is used in compensating the motion vector through the rotation transformation.

FIG. 6 shows a rotation transform express and an exercise according to an exemplary embodiment of the present invention.

If one or more light lines are positioned between the sensors, it faces a trouble in determining the direction of the motion. Thus, if the thickness of the grid line within the transmitting and receiving distance of the grid signal transmitter 100 is larger than the distance between the sensors, there is no problem in determining the direction of the motion. Here, a method of intercepting the light is used in forming the grid light, and it is thus easy to increase the thickness of the line.

FIG. 7 shows a motion vector processor of the grid signal receiver 200 according to a first embodiment of the present invention. Referring to FIG. 7, the grid signal receiver 200 includes the signal receiver 220 provided as the sensors for sensing the light, and the motion vector processor 240 receiving the sensed signal and calculating the motion. In this embodiment, the configuration of the motion vector processor is as follows.

A direction detector 241 may sense the moving direction of the grid signal transmitter 100. A line detector 242 may generate a pulse every time when one line moves. Then, a motion vector extractor 244 may generate a motion vector with respect to the horizontal and vertical directions and transmit it to a slope-based motion vector compensator 245.

The motion vector compensator 245 may compensate the motion vector according to the slope angles θ. At the same time, the slope detector 243 may transmit the slope angle θ of the transmitter based on the sensed signals 2H, 2V, 1E from the horizontal motion sensors A and B and the slope sensor E to the slope-based motion vector compensator 245. Here, the signal 2H is a vertical pattern infrared signal (IRX) received from the horizontal motion sensors A and B, and the signal 1E is a vertical pattern infrared signal (IRX) received from the slope sensor E.

The slope-based motion vector compensator 245 takes two motion vectors and θ, and then performs the above-described rotation transform to thereby output the compensated motion vector.

FIG. 8 shows a motion vector processor of the grid signal receiver 200 according to a second embodiment of the present invention. Referring to FIG. 8, the grid signal receiver 200 connects with a low-pass filter 246 at a final terminal to suppress variation of the motion vector due to noise and shaking generated in the transmitting and receiving terminal. Thus, the grid signal receiver 200 can obtain a smooth motion vector.

FIG. 9 shows a motion vector processor of the grid signal receiver 200 according to a third embodiment of the present invention. Referring to FIG. 9, the grid signal receiver 200 connects with a low-pass filter 246a at a backward terminal of the motion vector extractor 244 instead of connecting the low-pass filter at the final terminal as shown in FIG. 8, thereby reducing an error that may generated under an acceleration or negative-acceleration condition. Thus, the grid signal receiver 200 are decreased in the error due to the acceleration or the negative-acceleration.

FIG. 10 shows a motion vector processor of the grid signal receiver 200 according to a fourth embodiment of the present invention. The use of the low-pass filter 246 shown in FIG. 8 for suppressing the shaking is a passive method. More aggressively, as shown in FIG. 10, an anti-shaking decision unit 247 utilizes an algorithm for estimating actual shaking and generates a halt condition for the motion vector extractor, so that motion vector extraction can be free from an error due to minute motion.

FIG. 11 shows a motion vector processor of the grid signal receiver 200 according to a fifth embodiment of the present invention. If a motion vector moves as much as a unit in accordance with the grid motion between the grid lines, rough motion may be displayed. This is because of the limit of the grid resolution in light of a structure in this method. However, if a predetermined cycle Twidth, which means the moving speed about the motion of the grid generated in the grid signal transmitter 100 is set as a reference of the determination, proper compensation is possible. The acceleration and the negative-acceleration may be determined depending on the value of the cycle Twidth, and therefore a method for calculating a motion vector compensated corresponding to this has to be considered.

At this time, the predetermined cycle Twdith may be generated from a pulse width demodulator (PWDM) 248 that converts a pulse signal into a digital signal. A pulse-based motion vector compensator 249 may compensate the motion vector according to the predetermined cycle given by the pulse width demodulator 248. Such a compensated motion vector may be transmitted to the slope-based motion vector compensator 245.

According to an embodiment of the present invention, two methods may be considered in realizing the method of receiving the grid signal and calculating the motion vector. One is to achieve the motion vector processor in the form of hardware, and the other is to convert/achieve the inner function of the motion vector processor in the form of software (firmware) using a micro control unit (MCU).

FIG. 12 is a block diagram of the grid signal receiver achieved in the form of hardware according to an exemplary embodiment of the present invention. Referring to FIG. 12, the hardware type is divided into a dotted line where an A-chip 201 and a B-chip 202 are separately developed and merged into one package (board), and a solid line of two independent chip solutions. In a particular case of the B-chip 202, there may be necessary a built-in serial interface 254 for data communication with an application.

The software type is divided into a case where the MCU is externally provided (see FIG. 13) and a case where the MCU is internally provided (see FIG. 14) with respect to the application.

FIG. 13 is a block diagram of the grid signal receiver 200 achieved in the form of software according to a first exemplary embodiment of the present invention. Referring to FIG. 13, if the MCU 260 is externally provided, the signal receiver 220 and the MCU 260 are both provided in one board 203, and the MCU 260 communicates with the application. The MCU 260 is internally provided with a series of programs to perform the functions of the motion vector processor, and receives the signal by externally connecting GPIO or IRQ (or combination thereof) pins to the signal receiver 220, so that the serial interface 264 can access the application.

Such a software type has an advantage that an independent board can be flexibly developed in consideration of the MCU corresponding to the application. On the other hand, the MCU feature of the independent board has to be dependent on the application, and thus an evaluation and a test about whether the selected MCU is suitable may be required whenever the application changes.

FIG. 14 is a block diagram of the grid signal receiver 200 achieved in the form of software according to a second exemplary embodiment of the present invention. Referring to FIG. 14, development of a device where the application 21 is provided with a built-in MCU 22 may be limited to the signal receiver 220. Since the built-in MCU 22 of the application is used, a motion vector processor has to be programmed in consideration of resources previously occupied by the application.

Although some embodiments have been provided to illustrate the present invention, it will be apparent to those skilled in the art that the embodiments are given by way of illustration, and that various modifications and equivalent embodiments can be made without departing from the spirit and scope of the present invention. Accordingly, the scope of the present invention should be limited only by the accompanying claims and equivalents thereof.

### DESCRIPTION OF DRAWINGS

FIG. 1 shows a wireless pointing system using a grid pattern.

FIG. 2 shows an example of determining motion by a grid signal receiver in the wireless pointing system using the grid pattern.

FIG. 3 shows an error generated in the grid signal receiver when a grid signal transmitter is sloped.

FIG. 4 shows a wireless pointing system according to an exemplary embodiment of the present invention.

FIG. 5 shows an example that the grid signal receiver extracts a sloped angle of the grid signal transmitter.

FIG. 6 shows a rotation transform express and an exercise according to an exemplary embodiment of the present invention.

FIGS. 7 to 11 show a motion vector processor of the grid signal receiver according to embodiments of the present invention.

FIG. 12 is a block diagram of the grid signal receiver achieved in the form of hardware according to an exemplary embodiment of the present invention.

FIGS. 13 and 14 are block diagrams of the grid signal receiver achieved in the form of software according to an exemplary embodiment of the present invention.

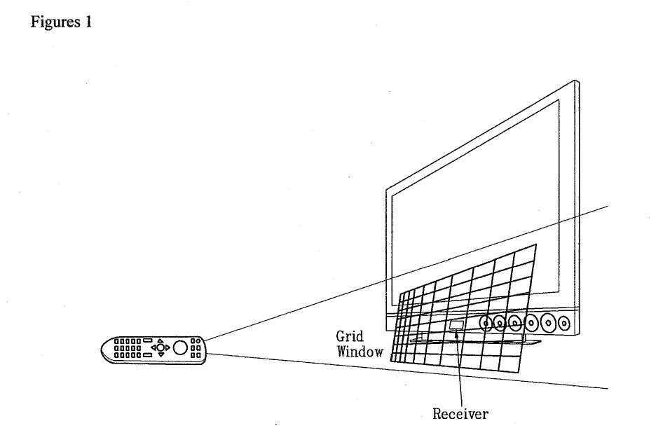

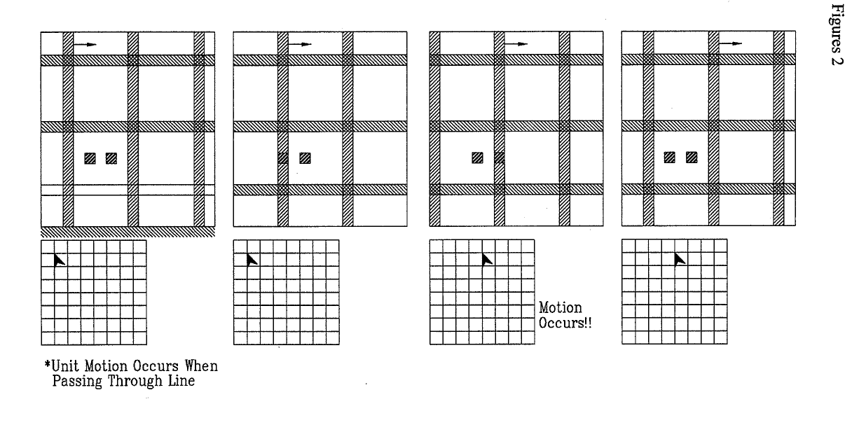

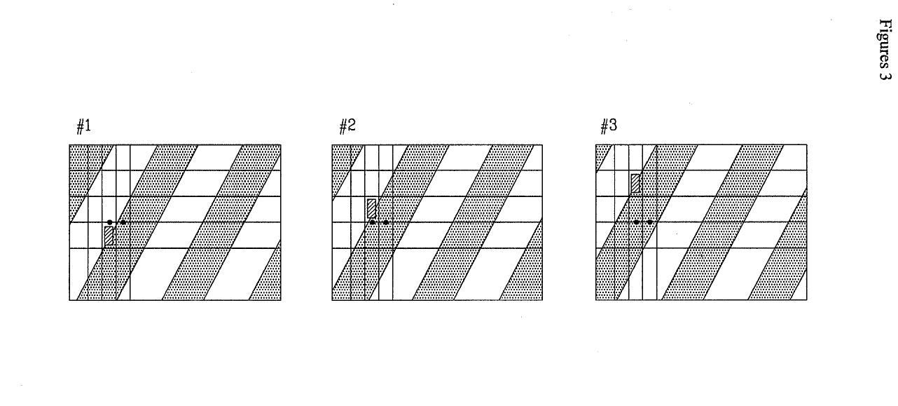

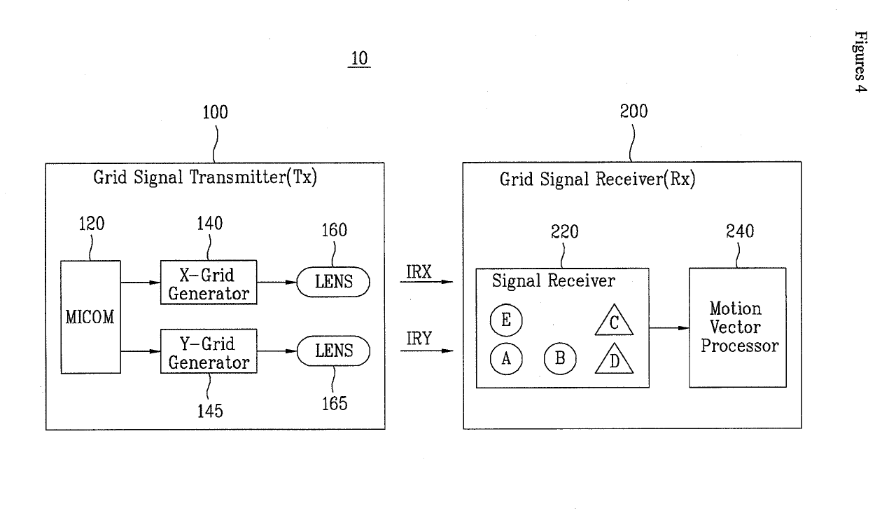

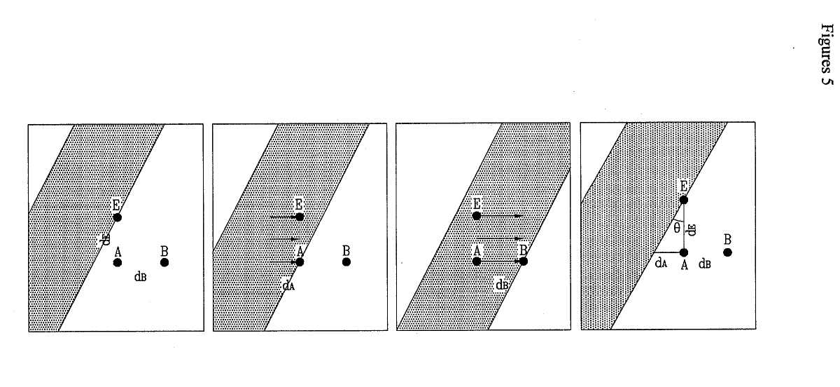

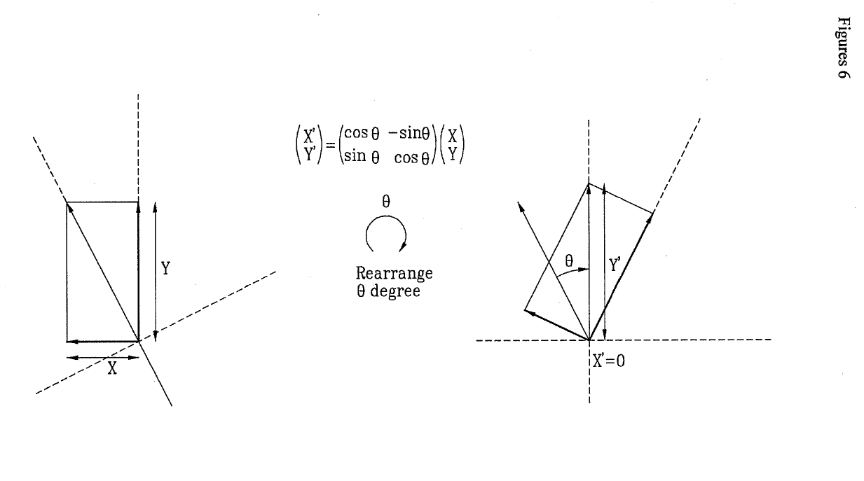

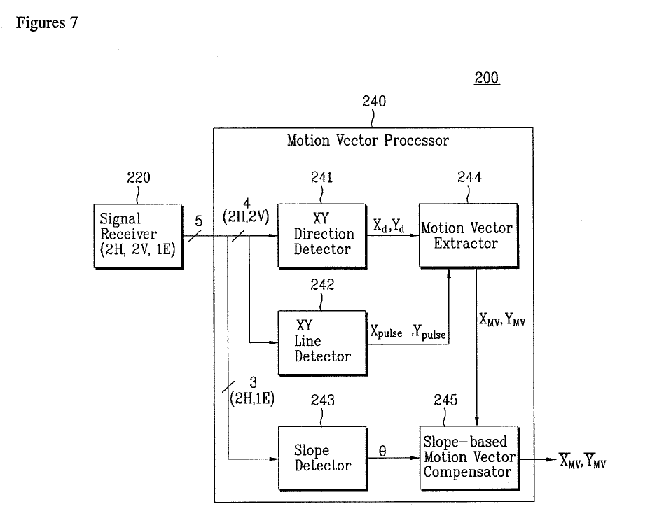

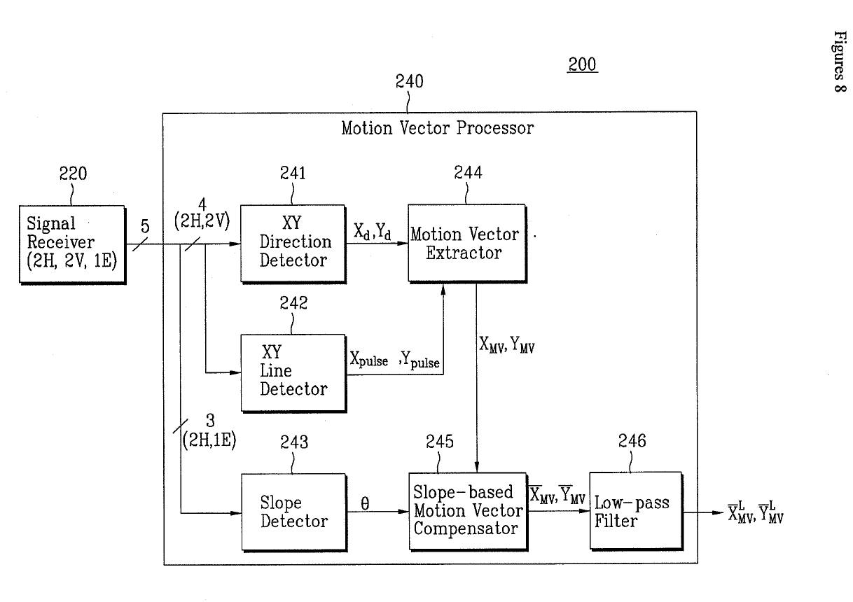

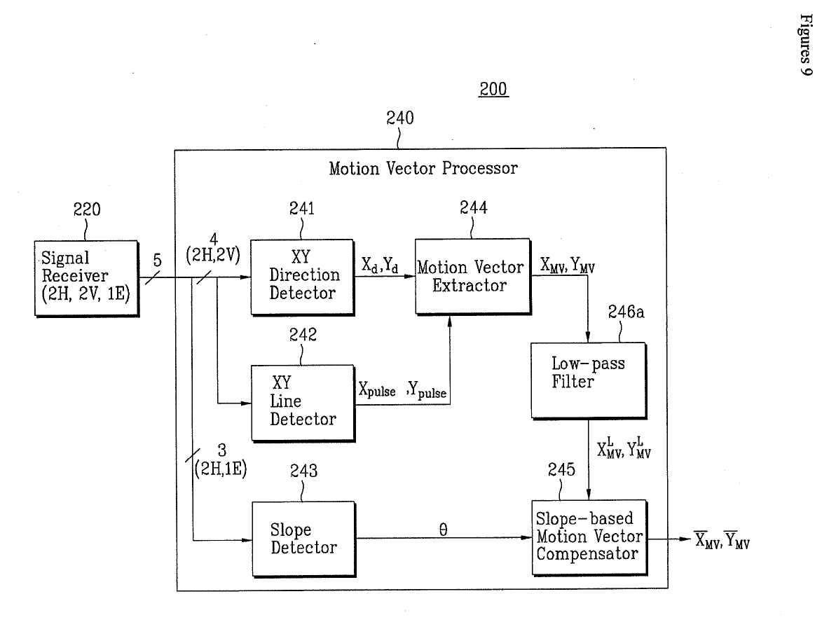

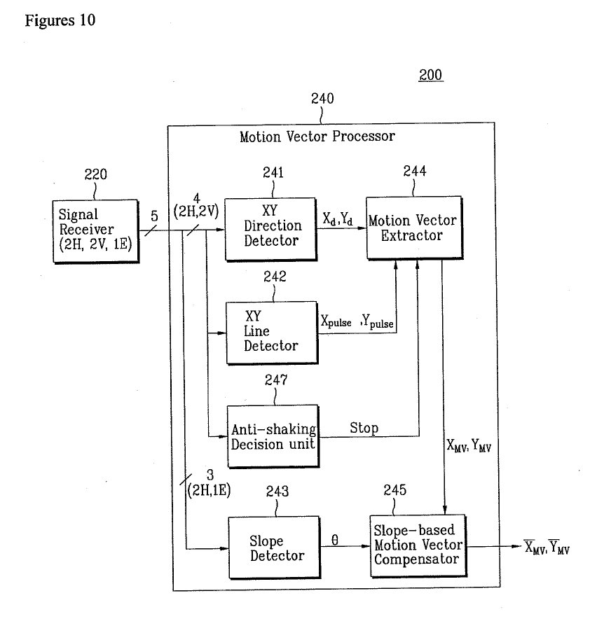

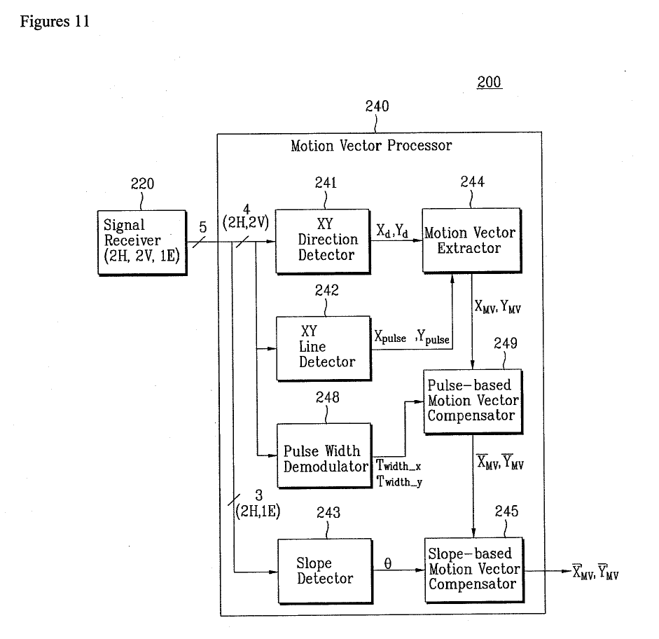

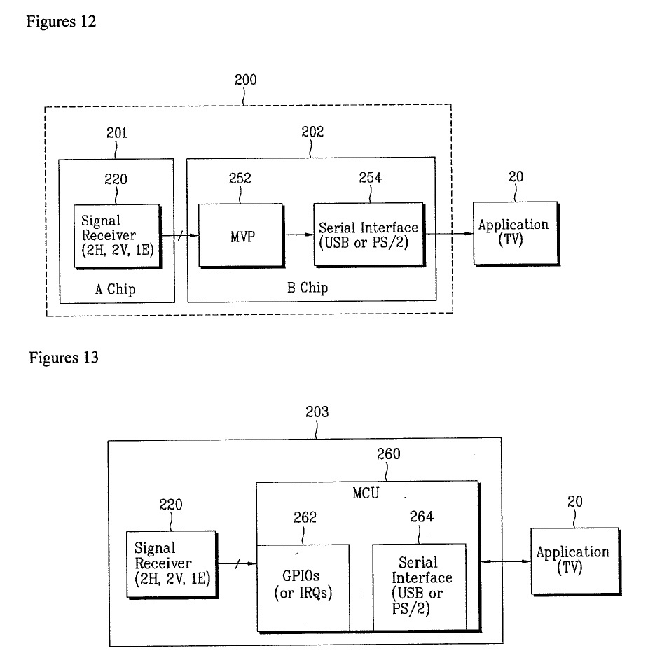

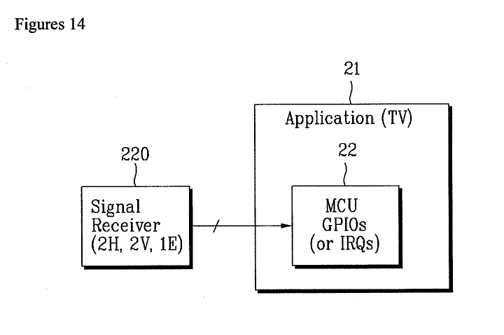

* reference numerals for drawings *

| | |
|---|---|
| 10: wireless pointing system | 20, 21: application |
| 100: grid signal transmitter | 200: grid signal receiver |
| 120: microcomputer | 140, 145; grid generator |
| 160, 165: lens | 220: signal receiver |
| 240: motion vector processor | 241: direction detector |
| 242: line detector | 243: slope detector |
| 244: motion vector extractor | |
| 245: slope-based motion vector compensator | |
| 246, 246a: low pass filter | |
| 247: anti-shaking decision unit | |
| 248: pulse width demodulation unit | |
| 249: pulse-based motion vector compensator | |
| 254: serial interface | |
| 260, 22: MCU | |

1. A grid signal receiver that receives a signal of a grid pattern from a grid signal transmitter and determines motion of the grid signal transmitter, the grid signal receiver comprising a slope sensor in addition to a motion sensor for sensing motion of a grid, the slope sensor sensing a slope of the grid to sense a slope of the grid signal transmitter.

2. The grid signal receiver according to claim 1, wherein the grid signal receiver comprises:
a pair of horizontal motion sensors which sense a vertical (Y-axis) pattern of the grid to sense horizontal (X-axis) motion;
a pair of vertical motion sensors which sense a horizontal (X-axis) pattern of the grid to sense vertical (Y-axis) motion; and
the slope sensor which senses the slope of the grid.

3. The grid signal receiver according to claim 2, wherein the slope sensor is arranged not on the same line as the pair of horizontal motion sensors or the pair of vertical motion sensors.

4. The grid signal receiver according to claim 3, wherein the slope sensor is arranged in a vertical direction with respect to one of the pair of horizontal motion sensors, or arranged in a horizontal direction with respect to one of the pair of vertical motion sensors.

5. The grid signal receiver according to claim 4, wherein the slope sensor is arranged so that a distance between the slope sensor and one horizontal motion sensor arranged in the vertical direction is equal to a distance between the pair of horizontal motion sensors, or a distance between the slope sensor and one vertical motion sensor arranged in the horizontal direction is equal to a distance between the pair of vertical motion sensors.

6. The grid signal receiver according to claim 3, wherein the slope sensor senses the vertical (Y-axis) pattern together with the pair of horizontal motion sensors and compares relative sensing times of the sensors to calculate slope information of the grid,
or the slope sensor senses the horizontal (X-axis) pattern together with the pair of vertical motion sensors and compares relative sensing times of the sensors to calculate slope information of the grid.

7. The grid signal receiver according to claim 2, wherein a vertical (Y-axis) pattern signal and a horizontal (X-axis) pattern signal of the grid are different in a frequency band.

8. The grid signal receiver according to claim 2, wherein
each sensor comprises
a photodiode to sense a grid signal; and
an optical filter to pass the frequency band of the grid signal.

9. The grid signal receiver according to claim 7, wherein the vertical (Y-axis) pattern signal and the horizontal (X-axis) pattern signal of the grid are different in the frequency band,
the horizontal motion sensor and the vertical motion sensor are provided with optical filters to pass the frequency bands of the vertical (Y-axis) pattern signal and the horizontal (X-axis) pattern signal, respectively, and
the slope sensor comprises an optical filter that passes either frequency band of the vertical (Y-axis) pattern signal or the horizontal (X-axis) pattern signal.

10. The grid signal receiver according to claim 1, further comprising a motion vector processor that receives a sensed signal from the respective sensors to process a motion vector, and calculates slope information of the grid to compensate the motion vector.

11. The grid signal receiver according to claim 10, wherein the motion vector processor comprises
a direction detector to detect a moving direction of the grid;
a line detector to generate a pulse every time when one grid line moves;
a slope detector to detect a slope of the grid;
a motion vector extractor to receive information about the moving direction of the grid from the direction detector and a pulse from the line detector and extract an X-axis motion vector (horizontal motion vector) and a Y-axis motion vector (vertical motion vector); and
a slope-based motion vector compensator to compensate the X-axis motion vector and the Y-axis motion vector on the basis of the slope information received from the slope detector.

12. The grid signal receiver according to claim 11, wherein the motion vector processor further comprises a low-pass filter that receives output of the slope-based motion vector compensator and performs low-pass filtering to suppress variation of a motion vector due to noise and shaking generated in a transmitting terminal or a receiving terminal.

13. The grid signal receiver according to claim 11, wherein the motion vector processor further comprises a low-pass filter that performs low-pass filtering by receiving the X-axis motion vector and the Y-axis motion vector of the motion vector extractor to reduce an error that may occur under acceleration or negative-acceleration conditions, and outputs the filtered X-axis and Y-axis motion vectors to the slope-based motion vector compensator.

14. The grid signal receiver according to claim 11, wherein the motion vector processor further comprises an anti-shaking decision unit to estimate shaking, so that the motion vector extractor is halted depending on the decision of the anti-shaking decision unit.

15. The grid signal receiver according to claim 10, wherein the motion vector processor comprises:
a direction detector to detect a moving direction of the grid;
a line detector to generate a pulse every time when one grid line moves;
a slope detector to detect a slope of the grid;
a motion vector extractor to receive information about the moving direction of the grid from the direction detector and a pulse from the line detector and extract an X-axis motion vector and a Y-axis motion vector;
a pulse width demodulator to convert a certain cycle about the motion of the grid into a digital value;
a pulse-based motion vector compensator to compensate the X-axis motion vector and the Y-axis motion vector received from the motion vector extractor on the basis of the converted digital value; and
a slope-based motion vector compensator to compensate the X-axis motion vector and the Y-axis motion vector received from the pulse-based motion vector compensator on the basis of the slope information received from the slope detector.

16. The grid signal receiver according to claim 10, wherein the plurality of sensors are provided as a first chip, and
the motion vector processor is provided as a second chip different from the first chip.

17. The grid signal receiver according to claim 10, wherein the plurality of sensors and the motion vector processor are provided as a single chip.

18. A wireless pointing system comprising:
a grid signal transmitter to generate and output a signal having a grid pattern signal; and
a grid signal receiver to process a motion vector to receive the signal of the grid pattern and calculate motion,
the grid signal receiver comprising a slope sensor in addition to a motion sensor to sense motion of a grid, so that a slope of the grid signal transmitter is sensed and the motion vector is compensated on the basis of slope information.

19. The wireless pointing system according to claim 18, wherein the grid signal receiver comprises
a pair of horizontal motion sensor to sense a vertical (Y-axis) pattern signal of the grid to sense horizontal (X-axis) motion;
a pair of vertical motion sensor to sense a horizontal (X-axis) pattern signal of the grid to sense vertical (Y-axis) motion; and
a slope sensor arranged not on the same line as the pair of horizontal motion sensors or the pair of vertical motion sensors to sense a slope of the grid.
